(19) United States
(12) Patent Application Publication
(10) Pub. No.: US 2006/0206611 A1
(43) Pub. Date: Sep. 14, 2006

(54) Method and system for managing programs with network address

(76) Inventor: Yutaka Nakamura, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/359,373

(22) Filed: Feb. 23, 2006

(30) Foreign Application Priority Data
Mar. 9, 2005 (JP) 2005-065565

(51) Int. Cl. G06F 15/173

(52) U.S. Cl. 709/226

(57) ABSTRACT

When a server in standby mode receives no heart beat communication message from a server in execution mode for a predetermined time period, the standby mode server assigns an IP address stored in a storage of the standby mode server to own server. And the standby mode server changes the current mode to execution mode and the server changed to the execution mode broadcasts the IP address assigned to own server and own MAC address for a predetermined period of time. When the same IP address as the IP address assigned to own server and the MAC address of the server in the standby mode are received; the execution mode server deletes the IP address that has been assigned to the own server.

### INCORPORATION BY REFERENCE

The present application claims priority from Japanese application JP2005-065565 filed on Mar. 9, 2005, the content of which is hereby incorporated by reference into this application.

### BACKGROUND OF THE INVENTION

The present invention relates to a method for taking over an IP address, an IP address takeover program, a server and a network system.

In a network system having computers connected with each other, when it is desired to realize distributed processing according to a client/server model, the network system is arranged to have a plurality of server computers capable of offering the same service in the network system in order to secure the availability of the system.

In this case, one of the plurality of server computers functions as an execution server and the other computers functions as standby servers.

When such a high-availability system is realized in the form of a network using internet protocol (IP), it is desirable from the client viewpoint that an identical IP address be assigned to server computers providing the same service.

When the IP address is duplicated and assigned at a certain time point and a plurality of MAC (Media Access Control) addresses correspond to one IP address, however, a sender cannot assign any one of the plurality of MAC addresses to transmit a packet.

To avoid this, a conventional high-availability network system is arranged so that an IP address is assigned to execution server (server computer in an execution mode) of server computers connected in the network and capable of providing the same service, but is not assigned to the other standby servers (server computers in their standby mode).

In this case, the standby server performs heart beat communication (periodically performs message exchange to confirm the status of the party computer). When detecting a system down, a communication failure, etc. in the execution server; the standby server takes over the IP address, which has been assigned to the execution server until then, and sets it as its own IP address.

Thereafter, the standby server transmits an ARP (Address Resolution Protocol) request having its own IP address and MAC address set therein in a broadcast manner. And the client, when receiving the request, updates a correlation between its IP address and MAC address in an ARP cache on the basis of the received ARP request.

From now on, the standby server activates an application process to provide a service, and acts as an execution server. The client requests various sorts of data to the execution server (original standby server) and receives the service therefrom. In this manner, server changeover is done (IP address takeover is implemented).

In the aforementioned server changeover method, a technique for switching between execution and standby modes in a short time is disclosed, for example, in JP-A-10-320323.

### SUMMARY OF THE INVENTION

However, anywhere in the above technique, no consideration is paid to the situation when the standby server fails to confirm the operational state of the party server due to a trouble or a delay in the heart beat communication channel. In other words, there is a problem in the above technique that, when a trouble or a delay took place in the heart beat communication channel but when the server itself does not fail, the respective servers judge themselves “to be transited to their execution mode”, which results in that the duplicate IP address is assigned to the execution and standby servers.

It is therefore an object of the present invention to provide an IP address takeover method in a network system having a plurality of servers providing the same service and securing a high availability, which can realize server switching without duplicate IP address assignment, even when the servers cannot confirm their operational states through heart beat communication.

In accordance with the present invention, the above object is attained by providing a network system which includes a server in an execution mode for providing service via a network and at least one server in standby mode for taking over the IP address of the execution server and changing into the execution mode when the execution mode server fails and wherein the server in the standby mode, when receiving no message by heart beat communication from the server in the execution mode for a predetermined period of time, is arranged to execute a step of assigning the IP address stored in a storage of the standby server to own server so that the mode is changed from standby mode to the execution mode, and a step of transmitting a massage including the IP address assigned to the own server and a MAC address of the own server in a broadcast manner for a predetermined period of time.

On the other hand, the execution mode server, when receiving the message including the same IP address as the IP address assigned to own server and the MAC address of the standby server, is arranged to execute a step of deleting the IP address, which has been so far assigned to the own server, and changing the execution server to the standby mode.

Other arrangement will be explained later in connection with an embodiment.

In accordance with the embodiments of the present invention, even when the servers cannot mutually confirm their operational modes due to a failure or the like in the heart beat communication channel, the IP address is assigned to any one of the servers providing the same service. Thus, the disabled service provision caused by the assignment of the same, duplicated IP address to a plurality of servers can be prevented.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram of a network system including server computers;

FIG. 2 is a flow chart for explaining the mode switching operation of the server in FIG. 1;

FIG. 3 is a flow chart for explaining the operation of the server in an execution mode in FIG. 1 when receiving an ARP request; and

FIG. 4 shows an example of a priority table for the server 1 (1A).

### DESCRIPTION OF THE EMBODIMENTS

A best form for embodying the present invention (which will be referred to as an embodiment, hereinafter) will be explained with reference to the accompanying drawings.

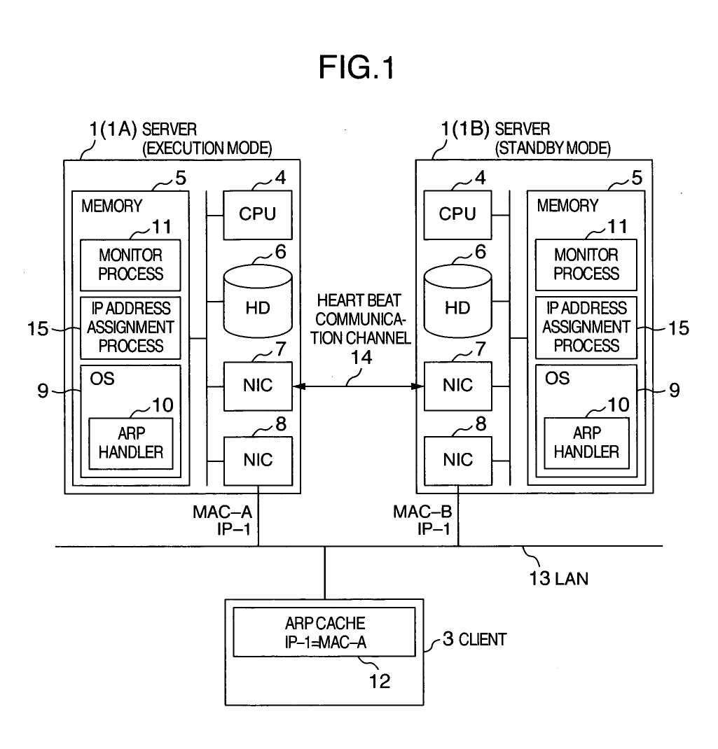

FIG. 1 shows a block diagram of a network system including server computers in accordance with an embodiment of the present invention.

The network system includes two server computers 1 (1A and 1B) for providing the same service, and a client computer (client) 3 for issuing a request of service provision to any of the server computers 1 (1A and 1B), the servers and the clients being connected by a local area network (LAN) 13.

In this case, such server computer(s) will be abbreviated merely to server(s), hereinafter.

Each of the servers 1 (1A and 1B), which is a web server, a file server or the like, transmits or distributes various sorts of data via the LAN 13 according to a request from the client 3. That is, the server 1 provides service to the client 3.

The LAN 13 is a network for connecting the servers 1 (1A and 1B) and the client 3. The LAN may be, for example, the Internet network or a local IP network.

The client 3 is a terminal which receives various sorts of data from the servers 1 (1A and 1B). The client may be, for example, a PC (Personal Computer).

The server 1 (1A or 1B) has a CPU (Central Processing Unit) 4, a memory 5, a hard disk unit (HD) 6, and network interface controllers (NICs) 7 and 8.

The NIC 7 controls a network interface connected to a heart beat communication channel 14, whereas, the NIC 8 controls a network interface connected to the LAN 13.

The CPU 4 of the server 1 (1A or 1B) realizes the function of an operating system (OS) 9 including control to the LAN 13 and the functions of a monitor process 11 and an IP address assignment process 15, by executing a predetermined program stored in the memory 5.

The above predetermined program realizes an application process (not shown) which provides various sorts of services to the client 3.

In the network system, for the purpose of acquiring a MAC address (identification information of the server 1) for an IP address to identify a communication party, the ARP is used. The OS 9 has an ARP handler 10 for performing various sorts of ARP processings including the transmission and reception of an ARP request, and the transmission and reception of an ARP reply.

An IP address takeover program is realized by the aforementioned ARP handler 10, monitor process 11, and IP address assignment process 15.

The IP address assignment process 15 assigns an IP address to its own server 1 (1A or 1B) and deletes the IP address.

The monitor process 11 establishes a heart beat communication with the server 1 (1A or 1B) via the heart beat communication channel 14 to monitor the operational state of the server 1 (1A or 1B) as its party. And the monitor process, when no heart beat communication message is received for a predetermined period of time from the party server 1 (1A or 1B), causes the IP address assignment process 15 to assign the IP address to its own server 1 (1A or 1B).

In other words, when the monitor process receives no heart beat communication message, the monitor process regards that the party server 1. (1A or 1B) failed, and causes its own server 1 (1A or 1B) to be transited to an execution mode.

In this embodiment, “the server 1 is transited to the execution mode” means that the IP address is assigned to the server 1 and the server 1 gets ready to receive various sorts of data via the LAN 13 according to a request from the client 3. Meanwhile, “the server 1 is transited to the standby mode” means that the IP address is deleted from the server 1 and the server 1 is put in a state (no service provision state) wherein the server 1 performs no data transmission to the client 3.

When the server 1 (1A or 1B) is transited to the execution mode, the monitor process 11 causes the ARP handler 10 to transmit the ARP request to the party server 1 (1A or 1B) via the LAN 13 until the server 1 (1A or 1B) can confirm the operational mode of the party server. In other words, the execution server informs the party server 1 (1A or 1B) that its own server 1 (1A or 1B) is already transited to the execution mode.

When the ARP handler 10 receives the ARP request from the party server 1 (1A or 1B), the monitor process 11 causes the IP address assignment process 15 to delete the IP address of its own server 1 (1A or 1B). In other words, the monitor process 11, when confirming the fact that the party server 1 (1A or 1B) was transited to the execution mode, causes its own server 1 (1A or 1B) to be transited to the standby mode.

Stored in the HD 6 (or in the memory 5) are the IP address to be set in the server 1 (1A or 1B) and the MAC address of the party server 1 (1B).

It is assumed in this example that the servers 1 (1A and 1B) are servers which provide the same service and that the same IP address is already stored in the HD 6 (or memory 5) in each of the servers. The input of the IP address may be manually entered by the administrator of the network system with use of a keyboard, a mouse, or the like. The ARP handler 10 reads out the IP address and the MAC address stored in the HD 6 (or in the memory 5) therefrom, and transmits an ARP request and an ARP reply. When receiving the ARP request, the ARP handler 10 refers to the HD 6 (or memory 5), and determines whether or not the received ARP request was transmitted from party one of the servers 1 (1A and 1B) providing the same service, that is, from the server 1 forming one of a pair of servers 1 in the heart beat communication.

In this connection, the HD 6 (or memory 5) corresponds to a storage recited in the appended claims.

The heart beat communication channel 14, in addition to the LAN 13, is provided between the servers 1 (1A and 1B) to directly connect the both servers 1 (1A and 1B).

The servers 1 (1A and 1B) can mutually recognize the operational mode of the party, by establishing a “heart beat communication” to exchange a message at predetermined time intervals (for example, at intervals of 10 minutes or less) using the heart beat communication channel 14.

It is assumed in this embodiment that the heart beat communication channel 14 is realized in the form of a LAN. However, the heart beat communication channel may be a serial line such as RS232C. Further, this can be realized by an external storage such as a hard disk shared by the servers 1 (1A and 1B).

In this connection, the number of such heart beat communication channels 14 may be single or plural.

Meanwhile, the client 3, when acquiring correspondence information between the IP address and the MAC address according to the ARP, updates an ARP cache 12 in a memory (not shown) of the client 3. The ARP cache 12 is a table showing a relation between IP addresses and MAC addresses associated therewith.

For example, the ARP cache 12 of the client 3 shown in FIG. 1 shows that the server 1 having an IP address of “1” has a MAC address of “A”.

In this connection, though only one client 3 is illustrated in FIG. 1, a plurality of such clients may be provided.

In this case, explanation is made in connection with a case where the server 1A is a server which is put in the execution mode to provide service to the client 3 via the LAN 13, and the server 1B is a server which is put in the standby mode without providing any service.

In the network system according to the present embodiment, when the server 1A in the execution mode cannot provide the service anymore due to a system down or the like, the server 1B in the standby mode recognizes this condition by the heart beat communication and changes the current mode to the execution mode. That is, the changeover of the operational mode of the server is carried out.

Details of constituent elements in the aforementioned network system will be explained by referring to flow charts.

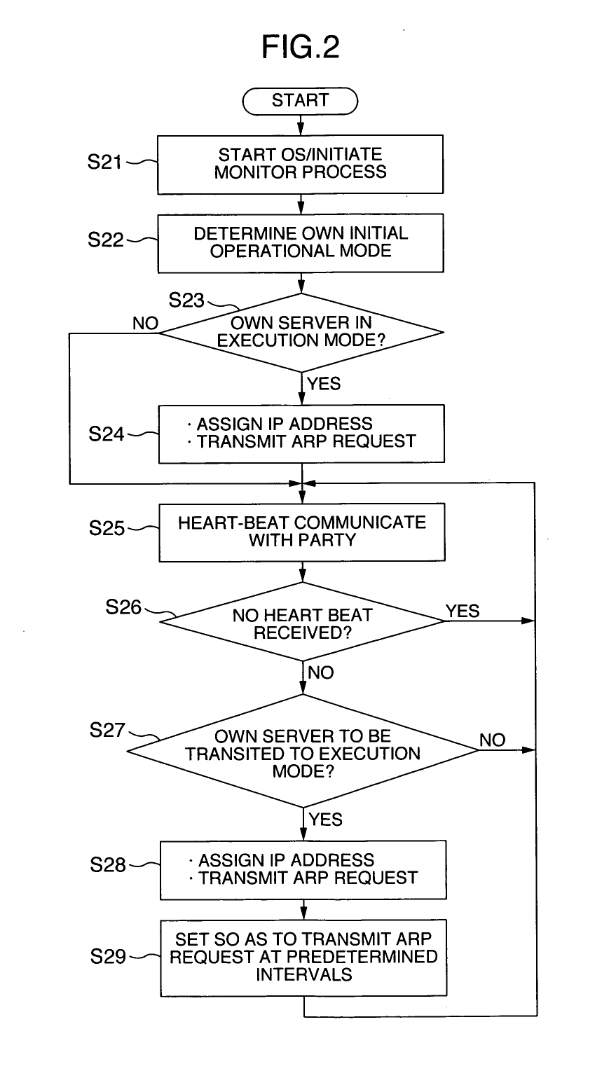

FIG. 2 is a flow chart for explaining how to take over the IP address of the server in FIG. 1 (the operation of the IP address takeover program).

How to take over the IP address of the server 1 will be explained below by referring to FIG. 1 and also FIG. 2.

In a step S21, first of all, when the power of the server 1 is turned ON, the server 1 initiates the OS 9 and the monitor process 11.

And in a step S22, the monitor process 11 determines its own initial operational mode. The initial operational mode (execution mode/standby mode) of its own server 1 is previously stored in the HD 6 or in the memory 5, and the monitor process 11 determines its own initial operational mode by referring to information about the initial operational mode.

When the operational mode of the server 1 is now the execution mode (YES in a step S23), the monitor process 11, in a step S24, assigns its own IP address to the IP address assignment process 15 to cause the ARP handler 10 to transmit an ARP request in a broadcast manner.

The transmission of the ARP request in the step S24 is because it is necessary to update the correspondence between the IP address and the MAC address in the ARP cache 12 of the client 3 or the like. Thereafter, the server 1 initiates an application process to provide service to the client 3 or the like.

When the operational mode of its own server 1 is the standby mode (NO in the step S23) in the step S23, the server proceeds to a step S25, in which the monitor process 11 establishes a heart beat communication with the party server 1 to monitor the operational mode of the party server 1. At this time, the server 1 does not assign the IP address to its own server 1.

When the monitor process 11 of the server 1 now determines reception of no heart beat from the party server 1 (NO, i.e., not received, in a step S26), that is, when the monitor process 11 receives no heart beat communication message from the party server 1 for a predetermined time due to a system down, a trouble in the heart beat communication channel 14, or the like; the monitor process 11 determines whether or not its own server 1 is transited to the execution mode in a step S27.

More specifically, when the operational mode of its own server 1 is the standby mode and the operational mode of the party server 1 is the execution mode, the monitor process 11 determines that its own server should be transited to the execution mode (YES in the step S27).

When its own server 1 is in the execution mode, on the other hand, the monitor process 11 determines that the transition to the execution mode is unnecessary (NO in the step S27). That is, the monitor process 11 returns to the step S25 and establishes a heart beat communication with the party server 1 to cause the application process to provide service to the client 3.

When the monitor process 11 determines that the server should be transited to the execution mode in the step S27 (YES in the step S27), the monitor process proceeds to a step S28 to cause its own server 1 to be transited to the execution mode. In other words, the monitor process 11 causes the IP address assignment process 15 to assign the IP address to its own server 1. The ARP handler 10 also transmits an ARP request in a broadcast manner to inform respective nodes in the network of the MAC address of its own server 1. Thereafter, the server 1 initiates the application process to provide service.

It is also assumed that, when the monitor process 11 (or the IP address assignment process 15) causes its own server 1 to be changed to the execution or standby mode, information indicative of the fact that the server 1 is currently in the execution or standby mode is previously stored in the HD 6 or in the memory 5.

And the ARP handler 10 of the server 1 transmits an ARP request via the LAN 13 at predetermined intervals until the monitor process 11 can recognize the operational mode of the party server 1 (step S29).

From now on, while repetitively executing a loop of the steps S25 and S26, the server 1 in the execution mode provides predetermined service to the client 3 under control of the activated application process.

When the monitor process 11 of the server 1 (1B) detects a reception of the ARP request from the party server 1 (1A) at the ARP handler 10 by the heart beat communication, the monitor process causes the IP address assignment process 15 to change its own server 1 to the standby mode. This means to delete the IP address from its server 1 (1B). In other words, the server 1 (1B) continues the heart beat communication, but stops the service provision (transmitting data based on a data transmission request from the client).

In this manner, even when the duplicate IP address is assigned to the both servers 1 (1A and 1B) due to a trouble or a delay in the heart beat communication, one of the servers 1 which first receives the ARP request from the party server 1 is quickly switched to the standby mode. As a result, the overlapped assignment of the IP address can be avoided as a temporary event.

Accordingly, this can reduce a risk that a packet cannot be identified to be transmitted to which one of the servers 1 from the client 3 and thus the client 3 cannot receive the normal service from the server 1 (1A or 1B).

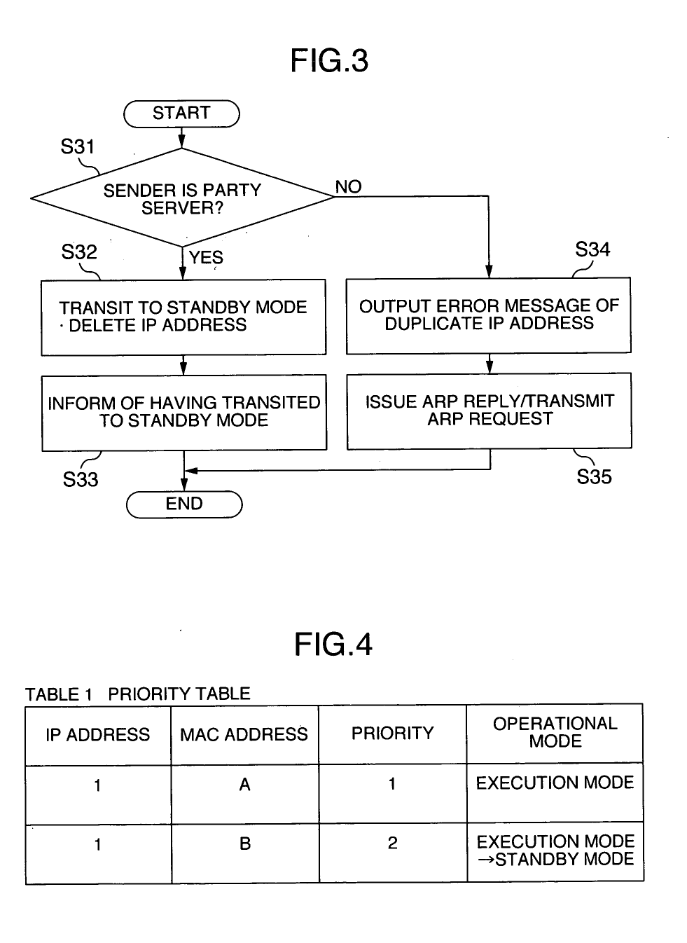

Explanation will next be made as to the operation of the server 1 in operation (in the execution mode) when receiving the ARP request, by referring to FIG. 3. FIG. 3 is a flow chart for explaining the operation of the server in the execution mode in FIG. 1 when receiving the ARP request.

The server 1 (1A) in operation, when first receiving the ARP request at the ARP handler 10, the monitor process 11 determines whether or not the sender of the ARP request is the party server 1 (1B) by the heart beat communication (step S31). This determination of the monitor process 11 is carried out by referring to the MAC address of the party server 1 (1B) of the heart beat communication stored in the HD 6 and also to the MAC address of the sender of the received ARP request.

The server 1 (1A) confirms the MAC address of the sender of the ARP request. This is for the purpose of avoiding the situation where, when erroneous assignment of the same IP address to nodes (servers) outside the network system causes its own server 1 (1A) to be transited to the standby mode, the network system cannot continuously provide the service.

When the sender of the ARP request is the party server 1 (1B) of the disabled heart beat communication (YES in the step S31), the monitor process proceeds to a step S32.

In the step S32, the monitor process 11 causes the IP address assignment process 15 to transit its own server 1 (1A) to the standby mode, delete the IP address assigned to its own server 1 (1A), and put the server in an unassigned IP address state.

In other words, when the monitor process 11 of the server 1 (1A) determines that the operational mode of the server 1 (1B) was changed and that the IP address so far assigned to the server 1 (1A) was assigned (taken over) to the server 1 (1B), the monitor process stops the application process of its own server 1 (1A) so as not to assign the IP address thereto.

At this time, it is assumed that the own server does not transmit an ARP response to the ARP request received at the step S31.

In this manner, even when the heart beat communication becomes disabled, the assignment of the same IP address to the both servers 1 (1A and 1B) can be prevented from being kept. In a step S33, the monitor process 11 of the server 1 (1A) informs the server 1 (1B) of the fact that its own server 1 (1A) was transited to the standby mode and the IP address was deleted. This notification is assumed to be carried out through the LAN 13 or heart beat communication channel 14. Since the server 1 (1B) when receiving the notification can confirm the state of the server 1 (1A), the server 1 (1B) causes the ARP cache 12 of the other client 3 to be updated by lastly transmitting the ARP request.

This is for the purpose of reliably setting the MAC address of the server 1 (1A) in the ARP cache 12, even when the client 3 already receives the ARP request from the server 1 (1A) (even when the MAC address of the server 1 (1A) is already stored in the ARP cache 12). And the monitor process 11 stops the transmission of the ARP request so far done at predetermined intervals by the ARP handler 10.

When the sender of the ARP request received by the server 1 (1A) is not the party server 1 (1B) in the step S31 (NO in the step S31), the monitor process proceeds to a step S34. In other words, when the MAC address of the sender of the received ARP request is different from the MAC address of the party server 1 (1B) of the heart beat communication, the monitor process goes to the step S34.

In the step S34, the monitor process 11 of the server 1 (1A) outputs an error message indicative of the duplicate IP address. At this time, the error message may be output to a display means such as a monitor in the server 1 (1A) or may be informed in the form of a mail or the like.

With the arrangement, the administrator of the network system can know the fact that the same IP address as the server 1 (1A or 1B) was erroneously set for the other nodes or that the IP address was incorrectly used.

In a step S35, the ARP handler 10 of the server 1 (1A) issues to the node of the sender an ARP reply having its own IP address and MAC address set therein to notify the sender node of the duplication of IP address. Having received the ARP rely, the sender node knows that the IP address is duplicated. The ARP handler 10 of the server 1 (1A) broadcasts an ARP request indicative of the MAC address of its own server 1 (1A) being set to update the MAC address for the IP address in the ARP cache 12 of the client 3 to the MAC address of the server 1 (1A).

In this manner, the setting of the MAC address of another node in the ARP cache 12 can be prevented. In other words, network traffic can be prevented from being confused.

As has been explained above, when the server 1 (1B) in the standby mode detects a disabled heart beat communication with the other server 1 (1A), the server 1 (1B) changes the operational mode to the execution mode to set the IP address. That is, the IP address so far set in the server 1 (1A) is taken over. At this time, the server 1 (1B) transmits the ARP request in a broadcast manner until the server 1 (1B) can confirm the mode of the other server 1 (1A), And when the server 1 (1A) receives the ARP request from the other server 1 (1B), the server 1 (1A) is changed to the standby mode. As a result, even when the servers 1 (1A and 1B) cannot confirm their modes due to a trouble or the like in the heart beat communication channel 14, the same IP address can be avoided from being duplicated and assigned.

Even when the execution mode (of the execution server) is changed between the servers 1 (1A and 1B), it is only required for the client 3 to set the same IP address to access the server 1. As a result, the switching between servers 1 can be made transparent to the user.

The above embodiment has been explained in connection with the case where the server 1 (1B) in the standby mode is used to take over the IP address and continue the service. However, the server 1 (1A) in the execution mode can continue the service on the basis of a previously-defined priority.

In other words, even when its own server 1 is already in the execution mode in the step S27 of FIG. 2, the monitor process 11 compares the priority of its own server 1 with the priority of the party server 1. And when detecting that the priority of its own server 1 is higher, the monitor process 11 executes the steps S29 and S28.

On the other hand, when the server 1 in the execution mode determines that no heart beat is received from the party server 1 and when the monitor process 11 compares the priority of its own server 1 with the priority of the party server 1 and determines the priority of its own server 1 is lower, the execution server 1 is changed to the standby mode. That is, the execution server deletes the IP address as in the step S32, and informs the party server of the fact that the execution server was transited to the standby mode as in the step S33.

The above priority comparison is carried out by the monitor process 11 referring to the priority table which indicates the priorities of the servers 1 (1A and 1B) and which is stored in the HD 6 or in the memory 5.

FIG. 4 shows an example of a priority table of the server 1 (1A).

As shown in FIG. 4, the priority table contains items relating to the IP address and MAC addresses of the servers 1 (1A and 1B) for heart beat communication, and priorities when the servers are changed over.

The priority table may include an item relating to the current operational modes (execution and standby modes) of the servers 1 (1A and 1B).

In FIG. 4, for example, of the servers having an IP address of “1”, the server 1 (1A) having an MAC address of “A” has a priority of “1” and its current operational mode is the execution mode. The server 1 (1B) having a MAC address of “B” has a priority of “2” and its current operational mode is the execution mode.

When the priority of its own server 1 (1A) is higher than that of the other server 1 (1B) as shown in FIG. 4, the monitor process 11 keeps the execution mode and causes the ARP handler 10 to transmit an ARP request. When the priority of its own server 1 (1A) is lower, on the other hand, the monitor process 11 causes the IP address assignment process 15 to delete the IP address and to transit its own server 1 (1A) to the standby mode.

In this connection, the monitor process 11 may rewrite information about the item of the operational mode to the standby mode when its own server 1 (1A) was switched to the ‘standby mode’. Or the monitor process 11 may rewrite information about the operational mode of the server 1 (1B) to the ‘standby mode’ when the monitor process 11 received a notification telling that the server 1 (1B) was transited to the standby mode.

In this connection, information on the priority table may be manually entered by the administrator of the network system with use of a keyboard, a mouse or the like connected to the server 1 (1A or 1B). Further, the information about the priority table may be displayed on a display means such as a monitor so that the administrator can confirm the operational modes of the servers 1.

In the step S29 of FIG. 2, it is desirable that the interval of transmission of the ARP request by the ARP handler 10 be set so that the entry of the client 3 in the ARP cache 12 for the IP address will be valid.

The reason for the above conditions is as follows. When the same IP address was erroneously set for the other node, the transmission of the ARP request by the client 3 may involve a risk that the MAC address in the ARP cache 12 is rewritten to the MAC address of the other node.

When the server 1 detects the fact that the duplicate IP address was assigned to the other node, the server 1 broadcasts the ARP request having its own MAC address set therein. That is, the MAC address in the ARP cache 12 of the client 3 can be corrected. As a result, the disabled service provision to the client 3 caused by the confusion of the network traffic can be prevented, and therefore a network system having an availability higher than the prior art can be formed.

Although the above explanation has been made in connection with the case where two of the servers 1 providing the same service are used in the foregoing embodiment, three or more of such servers 1 can be provided.

In this case, in the aforementioned priority table (refer to FIG. 4), information about a plurality of servers 1 having the standby mode will be described. And when the server 1 in the standby mode becomes disabled in the heart beat communication with the server 1 in the execution mode, the standby server refers to the priority table. When the standby server has its own highest priority among the standby mode servers 1 described in the priority table, the standby server changes its mode to the execution mode. If the standby server 1 has its own second or subsequent priority, the standby server will not change the mode to the execution mode.

With such an arrangement, even when two or more of servers 1 in the standby mode are present, one of such standby servers can change the mode to the execution mode (take over the IP address).

The present invention is not limited to the above specific embodiments but can be applied in various ways without departing from the spirit and scope thereof.

Although its own server 1 (1B) transmits the ARP request until its own server can confirm the mode of the party server 1 (1A) in the step S29 (step S28) of FIG. 2, for example, in the foregoing embodiment; the message to be transmitted at this time may be any message other than the ARP request so long as the message includes the MAC address of the server 1 (1B).

That is, any message can be used so long as the server 1 (1A) can identify that the message is sent from the server 1 (1B).

The server 1 (1A or 1B) in the present embodiment can be realized by the IP address takeover program which executes the aforementioned processes, and the program can be provided to be stored in a memory (such as CD or ROM) readable by a computer. Further, the program can also be provided through a network.

It should be further understood by those skilled in the art that although the foregoing description has been made on embodiments of the invention, the invention is not limited thereto and various changes and modifications may be made without departing from the spirit of the invention and the scope of the appended claims.

1. An IP address takeover method in a network system including a server in an execution mode for providing service via a network and at least one server in a standby mode for taking over an IP address of the execution mode server and changing its mode to the execution mode when the execution mode server fails,
wherein said standby mode server, when receiving no heart beat communication message from said execution mode server for a predetermined period of time, executes a step of assigning an IP address stored in a storage of said standby mode server to own server so that said standby mode is changed to the execution mode, and a step of transmitting a message including the IP address assigned said own server and a MAC address of the own server in a broadcast manner for a predetermined period of time, and
wherein said execution mode server, when receiving a message including the same IP address as the IP address assigned to own server and a MAC address of said standby mode server, executes a step of deleting the IP address that has been assigned to said own server so that said execution mode is changed to the standby mode.

2. An IP address takeover method according to claim 1, wherein each of said servers stores in its storage a priority table showing a priority of changing said each server to the execution mode, for each identification information of the servers performing a heart beat communication, and said standby mode server changes the mode of said own server to the execution mode when receiving no heart beat communication message from said execution mode server for a predetermined period and when the priority of the own server is higher than the other servers in said priority table.

3. An IP address takeover method according to claim 1, wherein the server changed from the execution mode to the standby mode further executes a step of transmitting a standby mode changeover message including the MAC address of said own server, and the server changed from the standby mode to the execution mode, when receiving said standby mode changeover message, stops transmitting a message including the IP address assigned to said own server and the MAC address of the own server.

4. An IP address takeover method according to claim 1, wherein the message, transmitted by said standby mode server and including the IP address assigned to said own server and the MAC address of said own server, is an ARP request.

5. An IP address takeover method according to claim 4, wherein said execution mode server, when receiving the ARP request from the server other than said standby server as a sender, transmits an ARP reply having the IP address and MAC address of said execution mode server set therein to said sender server.

6. An IP address takeover program for causing a computer to execute the IP address takeover method according to claim 1.

7. A server for performing a heart beat communication with another server providing the same service to establish mutual operational modes of the servers and for taking over an IP address, comprising:
a storage for storing therein a table showing the IP address to be assigned to said each server and a MAC address of said each server;
an ARP handler for transmitting an ARP request including the IP address read out from said table and the MAC address of the own server in a broadcast manner and receiving an ARP request from said each server;
an IP address assignment process for assigning the IP address read out from said table to said own server and deleting the IP address from said own server; and
a monitor process for performing said heart beat communication with the other server providing the same service via a communication line of said heart beat communication and, when receiving no heart beat communication message from said other server for a predetermined period, for assigning the IP address to said IP address assignment process and transmitting the ARP request to said ARP handler until said monitor process can confirm the operational mode of said other server.

8. A server according to claim 7, wherein said monitor process, when receiving the ARP request from the other server providing the same service, is arranged to cause said IP address assignment process to delete the IP address from said own server.

9. A server according to claim 8, wherein said monitor process, when receiving an ARP request from a node other than the other server providing the same service, is arranged to cause said ARP handler to transmit an ARP reply having the IP address and MAC address of said own server set therein to said node and to transmit an ARP request having the IP address and MAC address of said own server set therein.

10. A network system comprising a plurality of the servers according to claim 7.
